(19) United States
(12) Patent Application Publication
(10) Pub. No.: US 2026/0134866 A1
(43) Pub. Date: May 14, 2026

(54) TOOL-USE REPRESENTATION FOR GENERATIVE MODELS

(71) Applicant: GOOGLE LLC, Mountain View, CA (US)

(72) Inventors: Pavankumar Reddy Muddireddy, Santa Clara, CA (US); Christopher Thomas Hidey, New York, NY (US); Fei Liu, Santa Clara, CA (US); Rahul Goel, Fremont, CA (US); Pararth Shah, Sunnyvale, CA (US)

(21) Appl. No.: 18/944,852

(22) Filed: Nov. 12, 2024

(51) Int. Cl. G10L 15/16; G10L 15/18; G10L 15/22

(52) U.S. Cl. CPC G10L 15/16; G10L 15/1815; G10L 15/22; G10L 2015/223

(57) ABSTRACT

Implementations relate to fine-tuning a pre-trained generative model (e.g., LLM) and/or utilizing the fine-tuned generative model, to generate a tool-use representation that includes one or more reasoning blocks for a user query that indicates a task performable via one or more application programming interfaces (APIs). The fine-tuned generative model can output a reasoning block or an indication that indicates end-of-reasoning, for each of one or more iterations of LLM processing that are performed responsive to receiving such user query. The one or more reasoning blocks can be generated interactively until the indication that indicates end-of-reasoning is produced in the tool-use representation. A response for the user query can be generated based on the tool-use representation that includes the one or more reasoning blocks. The one or more reasoning blocks can include a text reasoning block and/or a tool call reasoning block.

### BACKGROUND

Generative models, such as large language models (LLMs), are neural networks that find their applications in various domains and fields. Generative models have been developed and can be used to process natural language (NL) content and/or other input(s), to generate generative output that reflects generative NL content and/or other generative content that is responsive to the input(s). For example, an LLM can be used to process NL content of “how to change DNS settings on Acme router”, to generate LLM output reflecting a response that includes several responsive NL sentences, such as: “First, type the router's IP address in a browser, the default IP address is 192.168.1.1. Then enter username and password, the defaults are admin and admin. Finally, select the advanced settings tab and find the DNS settings section”.

While capable of generating natural language content responsive to user input as described above, generative models, however, are typically not capable of leveraging external tools (or services) via application programming interfaces (“APIs”, such as an email API) to perform application actions such as sending an email or other tasks (e.g., changing DNS settings on Acme router, etc.). As a result, the capability of LLMs in leveraging external tools needs to be enhanced.

### SUMMARY

Implementations disclosed herein relate to augmenting generative models, such as large language models (LLMs), with the capability of utilizing external tools or services, e.g., application programming interfaces (APIs) associated with the external tools or services. An LLM is often pre-trained using a large corpus of unlabeled raw text to acquire knowledge that spans diverse subjects. The capability of the pre-trained LLM, however, is usually limited to language-centric tasks. To augment a pre-trained LLM with tool-use capabilities, the pre-trained LLM (or a different generative model) can be prompt-engineered and/or fine-tuned using one or more training instances described in consistent with various implementations of this disclosure, to acquire a fine-tuned LLM. In various implementations of the present disclosure, the fine-tuned LLM can be utilized to process a prompt generated based on at least on a user query (as input), to output a tool-use representation that includes one or more reasoning blocks.

In some implementations, the pre-trained LLM can be fine-tuned using multiple pairs of instructional prompts and ground truth outputs (as the training instances), where each pair can include a respective instructional prompt and a respective ground truth output that is paired with the respective instructional prompt. In some implementations, the respective instructional prompt can include, for instance, a respective user query, metadata associated with a list of APIs, and/or an instruction to generate a tool-use representation given the respective user query and the metadata associated with the list of APIs. In some implementations, optionally, different training instances (e.g., different pairs each having an instructional prompt and a ground truth output paired with the instructional prompt) can include metadata associated with different lists of APIs and/or different user queries.

In some implementations, as a non-limiting example, the instruction (when included in the respective instructional prompt) can be: “process the user query and/or the metadata associated with the list of APIs below to generate a reasoning block. Determine whether the reasoning block is enough to generate a response for the user query. For example, if the reasoning block is a tool call reasoning block providing information to call and execute an API, call and execute the API using the provided information, to generate an execution result. Update the reasoning block to include the execute result at the end. If the reasoning block (or the updated reasoning block) is enough to generate a response for the user query, produce ‘<end of reasoning>’ and attach it to the end of the reasoning block. If the reasoning block (or the updated reasoning block) is not enough to generate a response for the user query, generate a new prompt including the user query, the metadata associated with the list of APIs, and the reasoning block. Process the new prompt and repeat steps described above until a reasoning block that, when combined with all previously generated reasoning blocks, is enough to generate a response for the user query.”

In some implementations, the respective instructional prompt can include the respective user query and metadata associated with the list of APIs, without including the instruction to generate a tool-use representation. In some other implementations, the respective instructional prompt can include the respective user query and the metadata associated with the list of APIs, and further include the instruction to generate a tool-use representation. The present disclosure, however, is not limited thereto.

In some implementations, in the respective instructional prompt, the metadata associated with an API (or a tool, which, in some cases, can be considered as a service accessible via the API for the service) from the list of APIs can include a description that describes a function of the API (or the tool). In some implementations, optionally, the metadata associated with the API (or the tool) can additionally, or alternatively, include a list of function parameters (and/or types) of the API (or the tool), a type of returned data (e.g., integer, float, boolean, string, or other data type), and/or a document that describes the API (or the tool).

In some implementations, the document that describes the API can be a structured (or unstructured) documentation for utilization (e.g., execution) of the API. Such document can include, for instance, a description of API endpoint(s) (also referred to as “resource(s)”, which can be data object(s) such as movies, messages, or service(s)) accessible via the respective API, and a path (e.g., a uniform resource locator, “URL”) to the API endpoint(s). The document can further include an operation ID for an operation (e.g., HTTP method such as “POST”, “GET”, “DELETE”) to be performed on the resources (which, for instance, may be accessible over HTTP protocol) of the respective API, and a parameter list that lists parameters with their names (“language”, “region”), data types (“string” “integer”), and parameter descriptions. The document can further include response format (e.g., JSON) and schema, authentication method, and/or other information (e.g., error codes and descriptions for the error codes) of the API.

In various implementations, the aforementioned respective ground truth output can include a respective tool-use representation that includes one or more reasoning blocks. The respective tool-use representation in the respective ground truth output can be configured (e.g., manually curated, or generated using another generative model) based on the respective instructional prompt that is paired with the respective tool-use representation. For example, in some implementations, depending on content (e.g., a task to be performed) of the respective user query in a training instance, the one or more reasoning blocks paired with the respective user query in the training instance can be configured to include one or more text reasoning blocks and/or one or more tool call reasoning blocks.

In some implementations, a text reasoning block can identify, for instance, one or more parameters of a tool (or an API associated with the tool) and/or parameter value(s) for the one or more parameters of the tool (or the API associated with the tool). In this case, the text reasoning block may provide content (e.g., the parameter value(s)) for use, e.g., by a subsequent tool call reasoning block to execute the tool (or the API associated with the tool). It is noted that, the text reasoning block may not identify the tool (or the API associated with the tool), and the tool (or the API associated with the tool) may be selected/determined based on the types of the one or more parameters and/or the parameter value(s). But this is not required.

In some implementations, a tool call reasoning block can identify the API to be called, one or more parameters associated with the API, and the parameter value(s) for the one or more parameters associated with the API. Based on the tool call reasoning block, the API can be called and executed, to generate an execution result, and in response to the execution result being generated, the tool call reasoning block can be updated to include the execution result, for subsequent processing (e.g., generate a response for the user query, or generate an additional prompt to continue the processing using the additional prompt (or more prompts) until an indication, such as “<end of reasoning>”, which indicates the end of reasoning is produced).

In some implementations, a first reasoning block in the aforementioned one or more reasoning blocks can be a tool call reasoning block. In some other implementations, the first reasoning block in the aforementioned one or more reasoning blocks can be a text reasoning block. In some implementations, the one or more reasoning blocks may, but do not always, include a second reasoning block that follows the first reasoning block, regardless whether the first reasoning block is a tool call reasoning block or a text reasoning block. The second reasoning block (if generated) can be a tool call reasoning block or a text reasoning block. Optionally, the one or more reasoning block can include a third reasoning block, or even more reasoning blocks. The present disclosure, however, is not limited thereto.

In some implementations, the respective instructional prompt can be processed as input, using the pre-trained LLM, to generate one or more model outputs. The one or more model outputs can be compared (or first processed and then compared) with the respective ground truth output (e.g., the respective tool-use representation) to determine a difference, and one or more parameters of the pre-trained LLM can be adjusted (e.g., fine-tuned) based on the determined difference, to acquire the fine-tuned LLM.

In some implementations, in response to receiving a user input (e.g., a user request for performing a task to be fulfilled using at least one external tool/service), the fine-tuned LLM can process a prompt generated based at least on the user input (or a conversation having multiple dialog turns that include the user input), to generate one or more LLM outputs collectively reflecting a tool-use representation for performing the task. In various implementations, the tool-use representation for performing the task can include one or more reasoning blocks. The one or more reasoning blocks in the tool-use representation for performing the task can include one or more tool call reasoning blocks each associated with a tool (or an API of the tool, if there are multiple APIs associated with a single tool). A tool call reasoning block, for instance, can include a tool name (or tool identifier) of a tool (or an API associated with the tool if the tool is associated with multiple APIs) that is identified and selected for the specific user query, one or more parameters of the tool (or the API), one or more parameter values determined based on the specific user query for the one or more parameters, and/or an output from the tool based on processing of the one or more parameter values using the tool.

In various implementations, additionally, or alternatively, the one or more reasoning blocks (in the tool-use representation for performing the task) can include one or more text reasoning blocks. In some implementations, a text reasoning block can include content that is determined based on the user input and that provides a basis (e.g., parameter values) for a subsequent tool call reasoning block. For example, in response to receiving the user input, the fine-tuned LLM can process a first prompt generated based on the user input, to generate a first LLM output reflecting a first reasoning block (e.g., a tool call reasoning block, or a text reasoning block). In some implementations, the first prompt can include the user input and/or metadata associated with a list of tools (or a list of APIs that are associated with one or more tools). In some other implementations, the metadata associated with the list of tools (or the list of APIs) need not be included in the first prompt.

In some implementations, whether the first reasoning block is a text reasoning block or a tool call reasoning block can depend on a type of the task that is identified from the user input to be fulfilled. For instance, the first reasoning block can be a text reasoning block when the task identified from the user input is to perform a mathematical calculation or a mathematical operation. As another example, the first reasoning block can be a tool call reasoning block when the task identified from the user input is to perform a search, e.g., within a certain database or data source.

In some implementations, the first reasoning block (in the tool-use representation for performing the task) can be a tool call reasoning block. The tool call reasoning block can include a name or identifier of a tool (or an API associated with the tool), one or more parameters of the tool (or the API), and/or one or more parameter values determined from the user input for the one or more parameters. In some implementations, the tool (or the API) identified in the tool call reasoning block can be called and executed using the one or more parameter values for the one or more parameters associated with the tool (or the API), to generate/determine an execution result. In response to determining the execution result, the tool call reasoning block can be updated to include the execution result, e.g., for subsequent processing (if needed).

In some implementations, the first reasoning block (in the tool-use representation for performing the task) can include an indication (e.g., symbol or content such as <END OF REASONING>) that indicates an end of reasoning. In this case, a response to the user input can be generated based on content from the first reasoning block. In some implementations, the first text reasoning block does not include the indication that indicates the end of reasoning. In this case, a second prompt can be generated based on the first text reasoning block, the user input, and/or the metadata associated with the list of tools (or APIs). The second prompt can be processed as input, using the fine-tuned LLM, to generate a second LLM output reflecting a second reasoning block (be it a text reasoning block, or a tool call reasoning block).

Depending on whether the second reasoning block includes the indication indicating the end of reasoning, a third prompt, a fourth prompt, or more, can be generated and correspondingly processed using the fine-tuned LLM, until an output of the fine-tuned LLM (e.g., an N^{th} reasoning block) includes the indication that indicates the end of reasoning. In response to detecting the indication that indicates the end of reasoning, the tool-use representation can be processed to generate a response, and the response can be rendered in response to the user query.

In some implementations, the aforementioned user query can be received from a user via one or more user input devices (e.g., a microphone, a display, etc.) of a client device. In some of the various implementations, the user query can be received during a human-to-computer dialog between the user and an assistant application that is installed at, or accessible via, the client device. The assistant application can be an LLM-based assistant that includes or accesses a generative model (e.g., the aforementioned fine-tuned LLM), and/or other components (e.g., an automatic speech recognition module, “ASR” module).

In some implementations, the task identified in the user input can be fulfilled using one or more external tools. The one or more external tools can include, for instance, a search service, a python code executor, etc. In some implementations, the user input (e.g., “what is the color of the sky at night?”) may not identify a task performable using an external tool. In this case, the fine-tuned LLM may not generate a tool-use representation, but may instead, generate a model output reflecting natural language content (e.g., “I would say it is black”) responsive to the user query.

The preceding is presented as an overview of only some implementations disclosed herein. These and other implementations are disclosed in additional detail herein. For example, additional and/or alternative implementations are disclosed herein such as including one or more seed examples in a prompt to be processed using the fine-tuned LLM in response to receiving the user input that identifies a task to be fulfillment using an external tool/API. The one or more seed example can include, for instance, an example prompt as input (to be processed using the fine-tuned LLM) and an example tool-use representation as output (generated using the fine-tuned LLM), where the output includes at least one tool call reasoning block as described above. The at least one tool call reasoning block can describe a tool or an API (that is associated with the tool, if the tool is associated with multiple APIs) selected from a list of tools (or APIs) in the prompt, parameters to execute the tool or the API, and parameter values for the parameters to execute the tool or the API. The API can be executed using content from the at least one tool call reasoning block, to generate an execution result. In response to the execution result being generated, the at least one tool call reasoning block can be updated to include the execute result (e.g., at the end of the tool call reasoning block).

Various implementations can include a non-transitory computer readable storage medium storing instructions executable by a processor to perform a method such as one or more of the methods described herein. Yet other various implementations can include a system including memory and one or more hardware processors operable to execute instructions, stored in the memory, to perform a method such as one or more of the methods described herein.

### BRIEF DESCRIPTION OF THE DRAWINGS

FIG. 1A depicts a block diagram of an example environment that demonstrates various aspects of the present disclosure, and in which some implementations disclosed herein can be implemented.

FIG. 1B illustrates an example scenario showing generation and processing of a prompt determined based on a user query, in accordance with various implementations disclosed herein.

FIG. 2A depicts an example of human-to-computer dialog where a response to a tool-based user query is generated using a fine-tuned generative model, in accordance with various aspects of the present disclosure.

FIG. 2B depicts an example of a tool-use representation processed using the fine-tuned generative model to generate the response in FIG. 2A.

FIG. 3A depicts another example of human-to-computer dialog where a response to a tool-based user query is generated using a fine-tuned generative model, in accordance with various aspects of the present disclosure.

FIG. 3B depicts another example of a tool-use representation processed using the fine-tuned generative model to generate the response in FIG. 3A.

FIG. 4 depicts a flowchart illustrating an example method of generating a response for a tool-based user query, using a fine-tuned generative model, in accordance with various aspects of the present disclosure.

FIG. 5 depicts an example architecture of a computing device, in accordance with various implementations.

### DETAILED DESCRIPTION

Large language models (“LLMs”) have been so far pre-trained on a vast amount of data to be capable of handling language-centric tasks. However, the pre-trained LLMs are usually not capable of leveraging external tools or services, e.g., via application programming interfaces (“APIs”, such as an email API) associated with the external tools or service, to perform application actions such as sending an email or other tasks like changing DNS settings on Acme router, etc. As a result, there is a need to train or fine-tune the pre-trained LLMs in leveraging external tools or services.

The following description with reference to the accompanying drawings is provided for understanding of various implementations of the present disclosure. It's appreciated that different features from different implementations may be combined with and/or exchanged for one another. In addition, those of ordinary skill in the art will recognize that various changes and modifications of the various implementations described herein can be made without departing from the scope and spirit of the present disclosure. Descriptions of well-known or repeated functions and constructions may be omitted for clarity and conciseness.

The terms and words used in the following description and claims are not limited to the bibliographical meanings, and are merely used by the inventor to enable a clear and consistent understanding of the present disclosure. Accordingly, it should be apparent to those skilled in the art that the following description of various embodiments of the present disclosure is provided for the purpose of illustration only and not for the purpose of limiting the present disclosure as defined by the appended claims and their equivalents.

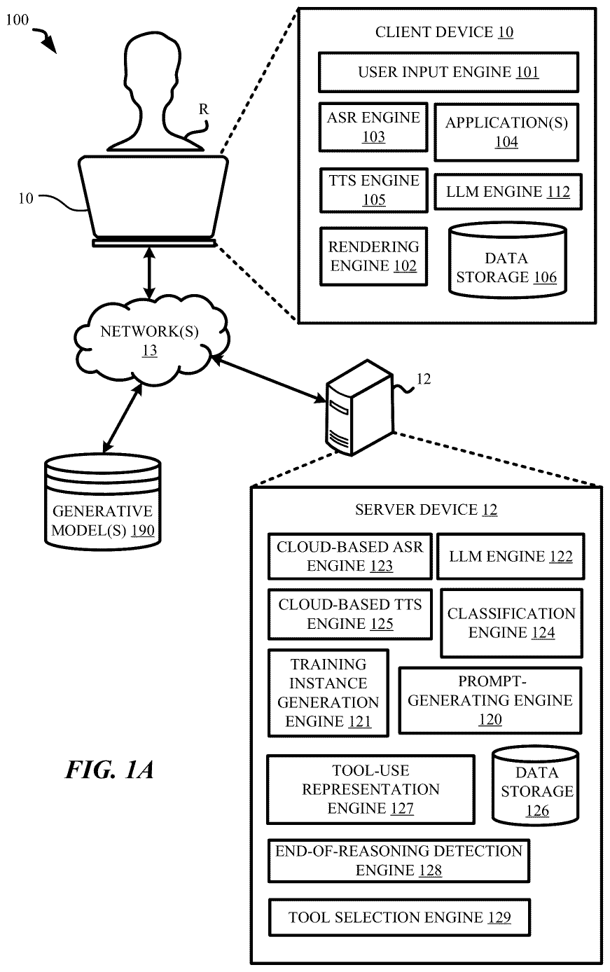

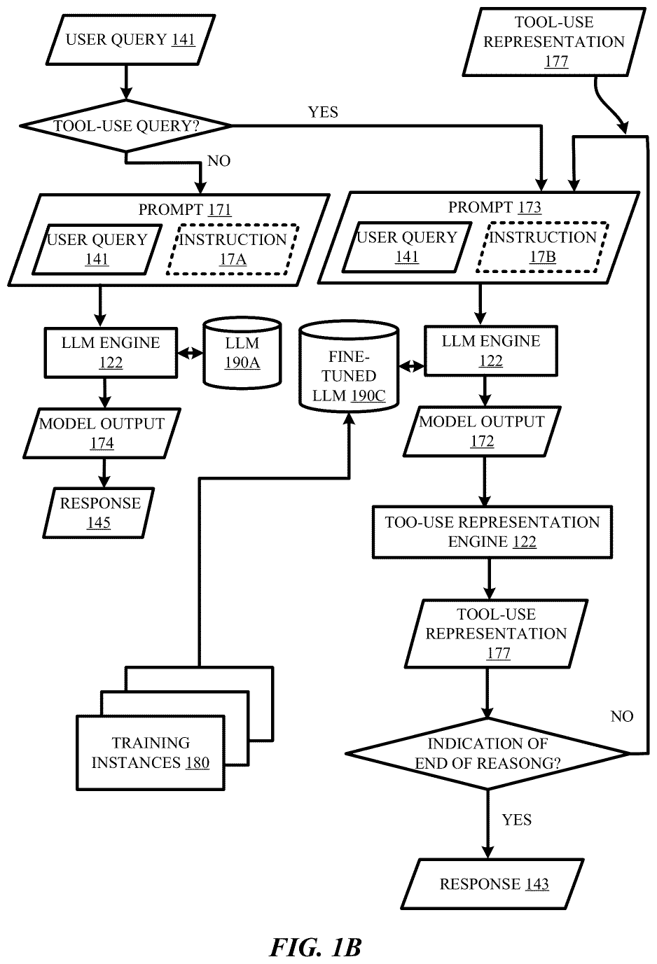

FIG. 1A is a block diagram of an example environment 100 that demonstrates various aspects of the present disclosure, and in which implementations disclosed herein may be implemented. As shown in FIG. 1A, the environment 100 can include a client computing device 10 (“client device”), and a server computing device 12 (“server device”) that is in communication with the client computing device 10 via one or more networks 13. The one or more networks 13 can include, for example, a local area network (LAN), a wide area network (WAN) such as the Internet, and/or any other appropriate network.

The client computing device 10 can be, for example, a desktop computing device, a laptop computing device, a tablet computing device, a mobile phone computing device, a computing device of a vehicle (e.g., an in-vehicle entertainment system), an interactive speaker, a smart appliance such as a smart television, and/or a wearable apparatus that includes a computing device (e.g., glasses having a computing device, a smart watch, a virtual or augmented reality computing device), and the present disclosure is not limited thereto.

In various implementations, the client computing device 10 can include a user input engine 101 that is configured to detect user input provided by a user (e.g., user R) of the client computing device 10. The user input may be provided by the user using one or more user interface input devices, such as a keyboard, a microphone, etc. The user input can be typed input, audible input, or any other applicable type of input. For example, the client computing device 10 can be equipped with a keyboard to receive typed input, and/or a mouse (or one or more hardware buttons) to receive a user click that selects one or more graphical user interface (GUI) elements that is rendered visually at a user interface of the client computing device 10. Additionally, or alternatively, the client computing device 10 can be equipped with one or more microphones that capture audio data, such as audio data capturing spoken utterances of the user and/or other sounds in an environment of the client computing device 10. Additionally, or alternatively, the client computing device 10 can be equipped with one or more vision components that are configured to capture vision data corresponding to images and/or movements (e.g., gestures) detected in a field of view of one or more of the vision components. Additionally, or alternatively, the client computing device 10 can be equipped with one or more touch sensitive components (e.g., a stylus, a touch screen, a touch panel, etc.) that are configured to capture signal(s) corresponding to touch input that is directed to the client computing device 10.

In various implementations, the client computing device 10 can include a rendering engine 102, one or more applications 104 installed locally at (or otherwise accessible via) the client computing device 10, and/or a data storage 106. In various implementations, the rendering engine 102 can be configured to provide content for audible and/or visual presentation to a user of the client computing device 10 using one or more user interface output devices. For example, the client computing device 10 can be equipped with one or more speakers that enable content (e.g., “search completed, do you want to review the hotels we find for you based on your requirement?”) to be provided for audible presentation to the user via the client computing device 10. Additionally, or alternatively, the client computing device 10 can be equipped with a display or projector that enables content (e.g., a list of hotels and associated hotel information) to be provided for visual presentation to the user via the client computing device 10.

The data storage 106 at the client computing device 10 (or data storage 126 at the server computing device 12) can store various types of files and/or data. For instance, the data storage 106 (or 126) can store a plurality of API documents each describing a different API (e.g., a description of function of the API, parameters associated with each API, type of data returned by the API, a path to call the API, etc.). Additionally, or alternatively, the data storage 106 (or 126) can store API descriptions (e.g., a one-sentence short description) that are extracted from the API documents. Additionally, or alternatively, in some implementations, the data storage 106 (or 126) can store metadata associated with a tool or a service, where the tool or the service can be associated with one or more APIs each called to perform a respective function.

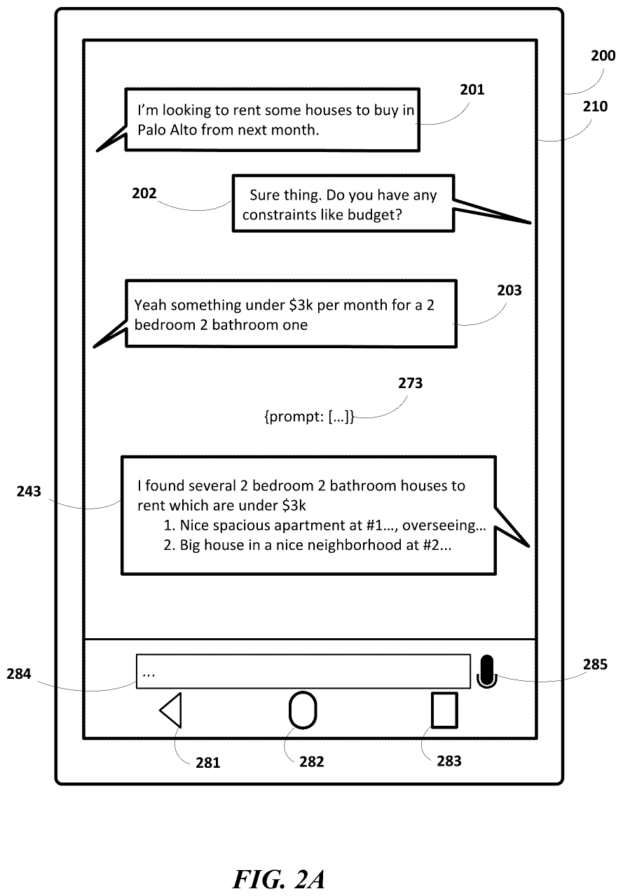

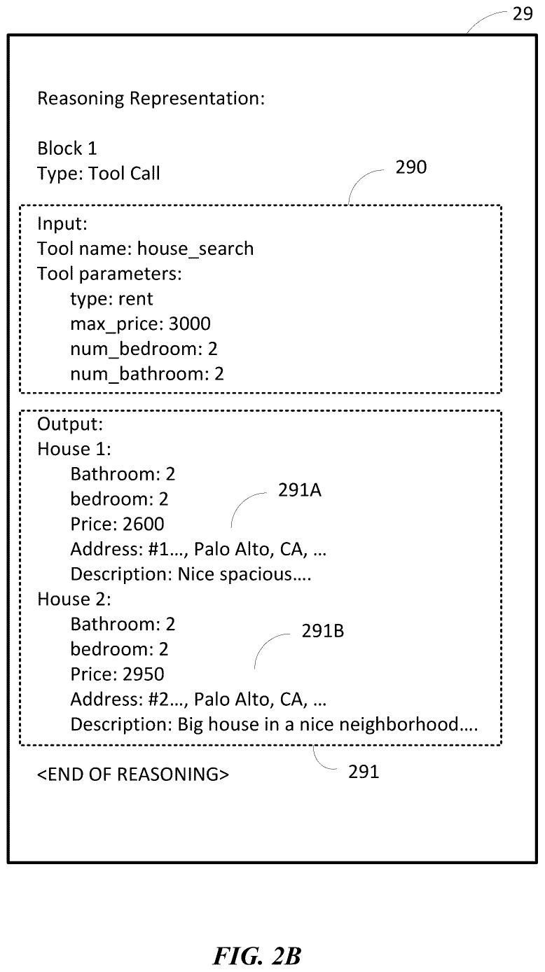

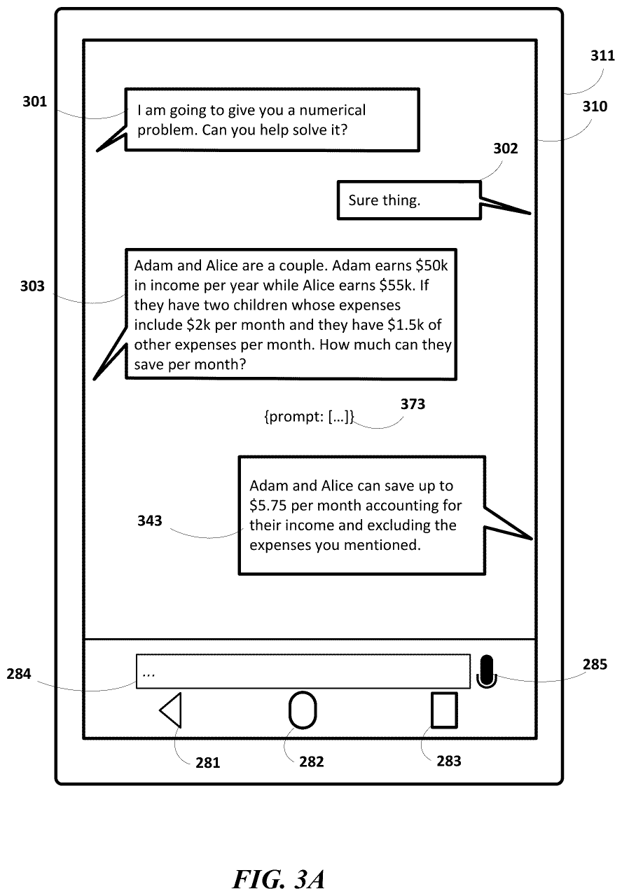

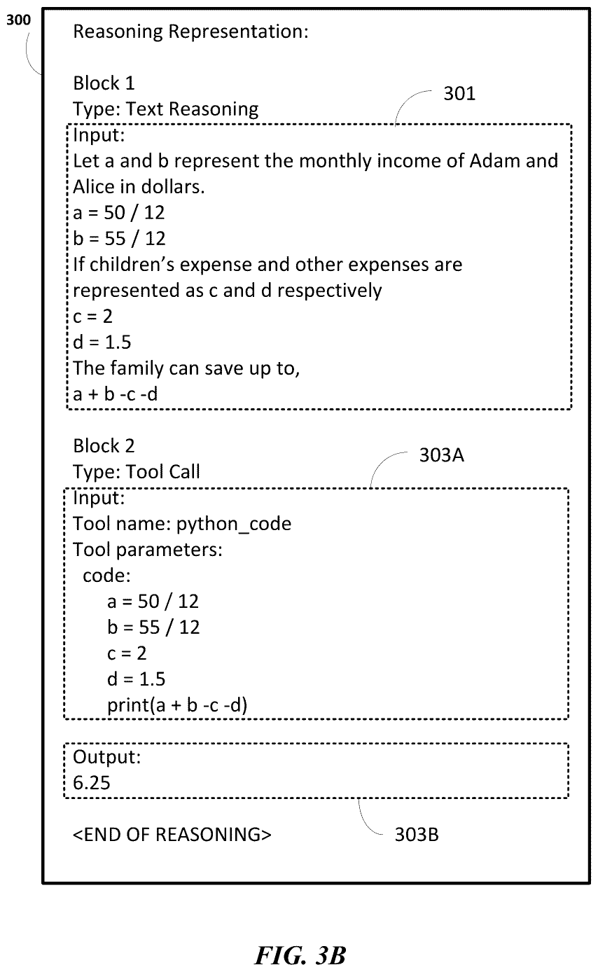

Additionally, or alternatively, in some implementations, the data storage 106 (or 126) can store a plurality of training instances to fine-tune a generative model. The generative model can be, for instance, a large language model (“LLM”) that has been pre-trained using enormous amounts of data collected from diverse sources such as webpages, electronic books, software code, electronic news articles, and machine translation data. The plurality of training instances can be applied to fine-tune the trained LLM in outputting a tool-use representation (as described in FIG. 2B or FIG. 3B) based on processing a prompt derived from a user query that requests performance of a tool-based task, where a response to the user query requesting performance of the tool-based task can be derived using the tool-use representation outputted by the fine-tuned LLM.

In some implementations, the plurality of training instances can each include an instructional prompt and a ground truth output that is paired with the instructional prompt. For example, the plurality of training instances can include a first training instance. The first training instance can include a first instructional prompt and a first ground truth output that is paired with the first instructional prompt. The first instructional prompt can include, for instance, a first user query, metadata associated with a list of APIs, and/or an instruction to generate a tool-use representation. For example, in some implementations, the first instructional prompt can include the first user query, the metadata associated with the list of APIs, and the instruction to generate a tool-use representation. As another example, in some implementations, the first instructional prompt can include the first user query and the metadata associated with the list of APIs, without including the instruction to generate a tool-use representation. In some implementations, the first instructional prompt can additionally include one or more seed examples as described previously. The present disclosure, however, is not limited thereto.

The first ground truth output can include a first tool-use representation that includes a first set of reasoning blocks. Depending on content (e.g., a task to be performed) of the first user query, the first set of reasoning blocks can include one or more text reasoning blocks and/or one or more tool call reasoning blocks. A text reasoning block can identify, for instance, one or more parameters and/or parameter value(s) for the one or more parameters (that are associated with an API regardless of whether the API is identified in the text reasoning block or not). A tool call reasoning block can identify the API to be called, one or more parameters associated with the API, and the parameter value(s) for the one or more parameters associated with the API. Based on the tool call reasoning block, the API can be called and executed, to generate an execution result, and in response to the execution result being generated, the tool call reasoning block can be updated to include the execution result which results in the first tool-use representation being completed or updated.

In some implementations, the first instructional prompt can be processed as input, using the pre-trained LLM, to generate one or more model outputs. The one or more model outputs can be compared (or first processed and then compared) with the first tool-use representation, to determine a first difference, and one or more parameters of the pre-trained LLM can be adjusted (e.g., fine-tuned) based on the determined first difference. In some implementations, the one or more model outputs can be generated using the pre-trained LLM during different iterations of LLM processing. For example, during a first iteration of LLM processing, the first instructional prompt can be processed as input, using the pre-trained LLM, to generate a first model output reflecting a first reasoning block. In this example, whether the first reasoning block includes an indication for an end of reasoning can be determined.

In response to determining that the first reasoning block includes an indication for an end of reasoning, further iteration of LLM processing can be bypassed, and the first reasoning block can be applied as the tool-use representation from which a response responsive to the user query can be derived. In some implementations, the first reasoning block can be a tool call reasoning block describing content (e.g., parameters and parameter values for the parameters) required for calling/executing an API that is configured to fulfill a task indicated in the user query. In this case, the tool-use representation can include an execution result of executing the API, in addition to including the first reasoning block.

In some implementations, in response to determining that the first reasoning block includes no indication for an end of reasoning, a second iteration of LLM processing can be performed. During the second iteration of LLM processing, a second instructional prompt can be processed as input, using the pre-trained LLM, to generate a second model output reflecting a second reasoning block. The second instructional prompt can include the user query and the first reasoning block. Whether the second reasoning block includes an indication for an end of reasoning can be determined. If the second reasoning block indicates an end of reasoning, further iteration of LLM processing can be bypassed. Otherwise, a third instructional prompt can be generated and processed, until a reasoning block output by the pre-trained LLM includes an indication for an end of reasoning.

In various implementations, the client computing device 10 can further include a plurality of local components. The plurality of local components can include, for instance, an automatic speech recognition (ASR) engine 103 and/or a text-to-speech (TTS) engine 105. Additionally or alternatively, the plurality of local components can include other component(s) such as a prompt-generating engine, and/or an LLM engine 112.

In some implementations, the one or more applications 104 can include an LLM-based assistant (may also be referred to as “assistant”, “chatbot”, etc., not illustrated in FIG. 1A). The ASR engine 103, the TTS engine 105, the prompt-generating engine, and/or the LLM engine 112 may be (but does not necessarily need to be) included in the LLM-based assistant. In some implementations, a user (e.g., user R) of the client computing device 10 may have a registered account associated with the LLM-based assistant and/or other application(s). The other applications can include, for example, a social media application, a video player, a note-taking application, a shopping application, a messaging application, and/or any other appropriate applications (or services), installed at, or accessible via, the client computing device 10.

The server computing device 12 can be, for example, a web server, one or more blade servers acting together to provide “cloud” infrastructure, or any other type of server as needed. In various implementations, the server computing device 12 can include cloud-based components the same as or similar to the plurality of local components installed at the client computing device 1. For example, the server computing device 12 can include a cloud-based ASR engine 123, a cloud-based TTS engine 125, a cloud-based prompt-generating engine 120, and/or a cloud-based LLM engine 122. In some implementations, the server computing device 12 can further include a training instance generation engine 121. The training instance generation engine 121 can be applied to generate the aforementioned training instances. Using one or more of the training instances, a pre-trained generative model (e.g., LLM 190A in FIG. 1B) can be fine-tuned to output a tool-use representation that includes one or more reasoning blocks based on processing of a user query. In some implementations, the one or more reasoning blocks can be generated in an iterative manner. For instance, a first prompt generated based at least on the user query can be processed using the fine-tuned LLM 190C (see FIG. 1B), to generate a first model output reflecting a first reasoning block.

If the first reasoning block does not include any indication that indicates an end of reasoning, the first prompt can be updated to include content from the first reasoning block (and therefore becomes a second prompt different from the first prompt). The second prompt can be processed, using the fine-tuned LLM 190C, to generate a second model output reflecting a second reasoning block. If the first reasoning block includes an indication that indicates an end of reasoning and if the first reasoning block is a tool call reasoning block, an API (or tool) identified in the tool call reasoning block can be executed using, e.g., parameter values for parameter(s) associated with the API (or the tool), to generate an execution result/output (output by the API). A response for the user query can then be generated based on the execution result/output and/or the first reasoning block.

If the second reasoning block includes an indication that indicates an end of reasoning, a response for the user query can be generated based on the first and second reasoning blocks (and execution results/outputs associated with the first or second reasoning block in case any of the first or second reasoning block is a tool call reasoning block). If, however, the second reasoning block further indicates no end of reasoning, a third prompt can be generated to include, for instance, content of the second prompt and content from the second reasoning block. A fourth prompt can be similarly generated and processed, until a subsequent reasoning block generated by processing the third or fourth (or other) prompt includes an indication that indicates an end of reasoning.

In various implementations, the ASR engine 103 (and/or the cloud-based ASR engine 123) can process, using one or more streaming ASR models (e.g., a recurrent neural network (RNN) model, a transformer model, and/or any other type of ML model capable of performing ASR), streams of audio data that capture spoken utterances, to generate corresponding streams of ASR output. The ML model(s) can be on-device ML models that are stored locally at the client computing device 10, remote ML models that are executed remotely from the server computing device (e.g., at remote server device 12), or shared ML models that are accessible to both the client computing device 10 and/or remote systems (e.g., the remote server computing device 12). The audio data can be acquired from audio recordings or can be generated by microphone(s) of the client computing device 10. Notably, the streaming ASR model can be utilized to generate the corresponding streams of ASR output as the streams of audio data are generated.

In some implementations, the corresponding streams of ASR output can include, for example, streams of ASR hypotheses (e.g., term hypotheses and/or transcription hypotheses) that are predicted to correspond to spoken utterance(s) of a user that are captured in the corresponding streams of audio data, one or more corresponding predicted measures (e.g., probabilities, log likelihoods, and/or other values) for each of the ASR hypotheses included in the streams of ASR hypotheses, a plurality of phonemes that are predicted to correspond to spoken utterance(s) of a user that are captured in the corresponding streams of audio data, and/or other ASR output. In some versions of those implementations, the ASR engine 103 and/or 123 can select one or more of the ASR hypotheses as corresponding recognized text (“transcript”) that corresponds to the spoken utterance(s) (e.g., selected based on the corresponding predicted measures).

The TTS engine (e.g., 105 and/or 125) can process, using TTS model(s), corresponding streams of textual content (e.g., content generated based on LLM or a predetermined text, etc.) to generate synthesized speech audio data that includes computer-generated synthesized speech. In additional or alternative implementations, the synthesized speech audio data can be pre-cached in memory or in one or more databases accessible by the client computing device 10.

In some implementations, the LLM engine 112 can be in communication with one or more generative models 190 (e.g., LLM 190A and LLM 190C in FIG. 1B), for natural language content (e.g., an instruction to generate a response to a tool-use request and/or an instruction to generate a response to a non-tool-use request) and/or other type of content (e.g., API documents for different APIs) to be processed using the generative model 190.

In some implementations, the prompt-generating engine of the client computing device 10 (or the prompt-generating engine 120 of the server device 12) can be configured to generate a prompt (e.g., textual prompt) to be processed as input using one of the generative models 190. In some implementations, the prompt-generating engine 120 can be included in the LLM engine 112.

In various implementations, the one or more generative models 190 can include a large language model (LLM) having less than 100 billion parameters, more than 100 billion parameters, or over 200 billion parameters, etc. The greater the number of parameters of an LLM, the more complex (or sophisticated) a task (e.g., specified in a user query or request) the LLM can handle. The LLM may be stored at client computing device 10, or at the server computing device 12. For instance, if the memory of the client computing device 10 restricts the storing of the LLM at the client computing device 10 or if a length of a textual prompt to be processed using the LLM exceeds a predetermined token length, the LLM may be stored at the server device 12. For instance, if the memory of the client computing device 10 does not restrict the storing of the LLM at the client computing device 10, the LLM may be stored at the client computing device 10, to reduce a latency in completing a task (e.g., specified in the user query or request), for instance, by avoiding data communications via the one or more networks 13.

In some implementations, when the generative model 190 is stored at the client computing device 10, the maximum token length of content (e.g., text) processable using the LLM may be a first maximum token length (e.g., 10,000). In some implementations, when the LLM is stored at the server device 12, the maximum token length of content (e.g., text) processable using the generative model 190 may be a second maximum token length (e.g., 30,000) that is greater than the first maximum token length.

In some implementations, the pre-trained LLM can be transformer-based. One non-limiting example of a pre-trained LLM is GOOGLE'S Pathways Language Model (PaLM). Another non-limiting example of a pre-trained LLM is GOOGLE'S Language Model for Dialogue Applications (LaMDA).

In some implementations, the server computing device 12 (or the client computing device 10) can further include a classification engine 124 and/or a tool selection engine 129. The classification engine 124 can be, for instance, a user query classification engine configured to classify user input/query. In some implementations, the user query classification engine can be configured to classify or determine whether a user query is a tool-use request for performing a task using one or more tools (e.g., via application programming interfaces, “APIs”) that are external to the LLM-based assistant. The “external” herein means that performing the task identified or indicated in the user query requires assistance from a service external to the LLM-based assistant, in addition to or instead of using inherent knowledge of the fine-tuned LLM(s) utilized by the LLM-based assistant. The inherent knowledge of the fine-tuned LLM(s) can be acquired during the pre-training of the LLM(s) using diverse training data acquired from different sources. The different sources, as described above, can include but are not limited to: webpages, electronic books, software code, electronic news articles, and machine translation data.

As a non-limiting example, assuming user R provides a typed input (or an audible input, or other types of input) of “help me book a hotel in St. Matthews, Kentucky” at an input field displayed at a user interface of the LLM-based assistant (that is installed at the client computing device 10). In this case, the user query classification engine 125 can classify the typed input of “help me book a hotel in St. Matthews, Kentucky” as a tool-use request for performing a task using an external tool or API (e.g., an API for booking hotels). In this case, the user query classification engine 125 classifies the typed input (e.g., “help me book a hotel in St. Matthews, Kentucky”) being (or including) a tool-use request based on determining that the typed input includes a request to perform a task of “hotel booking” and/or based on determining that a traveling API (e.g., associated with a travel app) from a plurality of APIs that are in communication with the LLM-based assistant is responsive to the task of “hotel booking”. In some implementations, optionally, the user query classification engine 125 can determine/classify that the typed input is (or includes) a tool-use request using one or more machine learning (ML) models trained to classify user queries.

As another non-limiting example, assuming user R provides audible input (or another type of input) of “what color do you get if mixing blue and yellow” at an input field displayed at a user interface of the LLM-based assistant. In this example, the user query classification engine 125 can classify that the audible input of “what color do you get if mixing blue and yellow” is not (or does not include) a tool-use request. In some implementations, the user query classification engine 125 can determine/classify that the audible input is not (or does not include) a tool-use request based on determining that the audible input includes a request for common knowledge and/or based on determining that none of the plurality of APIs that are in communication with the LLM-based assistant is responsive to natural language content of the audible input.

In some other implementations, the user query classification engine 125 can determine the exemplary audible input (e.g., “what color do you get if mixing blue and yellow”) does not include a tool-use request using one or more ML models trained to classify user queries. For instance, based on a model output of a ML model trained to classify user queries indicating that the exemplary audible input does not belong to any classification from one or more predefined classifications, the user query classification engine 125 can determine the audible input (e.g., “what color do you get if mixing blue and yellow”) as not including a tool-use request.

In some implementations, the one or more predefined classifications can include and only include a classification of a tool-use request. In some implementations, the one or more predefined classifications can include more than one classification. For instance, in some implementations, the plurality of predefined classifications can include: a first classification of tool-use requests performable using a first API (e.g., hotel_booking API) of the plurality of APIs available to the LLM-based assistant, and a second classification of tool-use requests performable using a second API (e.g., house_searching API) of the plurality of APIs available to the LLM-based assistant, etc.

In some implementations, the user query classification engine 125 can be further utilized to classify whether a user input includes a tool-use request of a particular type, e.g., a request to perform a particular type of tool-use task such as mathematical operation, house searching, hotel booking, etc. In some implementations, the tool selection engine 129 can be invoked by the user query classification engine 125 to select a particular tool (e.g., a python interpreter) or API (e.g., an API for the python interpreter), or select a particular set of tools (or APIs), for performing the particular type of tool-use task (e.g., mathematical operation). For instance, a user may direct a query (such as “If I need to pay a balance of $234.5 to my credit card, a water bill of $90.6, an energy bill of $202.3, and a monthly mortgage of $1851.7, how much in total I need to pay this month?”) to the LLM-based assistant. In this case, the user query classification engine 125 may classify that the query (e.g., “If I need to pay a balance of $234.5 to my credit card, a water bill of $90.6, an energy bill of $202.3, and a monthly mortgage of $1851.7, how much in total I need to pay this month?”) includes a request to perform a mathematical operation. Correspondingly, the tool selection engine 129 can select the python interpreter (or an API for the python interpreter) as a tool (or API) for performing the mathematical operation.

The python interpreter (or the API for the python interpreter) can be executed, e.g., based on parameters and values for the parameters that are extracted from a text reasoning block (e.g., which includes a python code of “a=234.5, b=90.6, c=202.3, d=1851.7, print(a+b+c+d)”, or a tool-representation that includes the text reasoning block) that is derived from a first model output of the fine-tuned LLM (e.g., 190C in FIG. 1B). The first model output of the fine-tuned LLM can be generated based on processing, as input, a prompt derived from the query (e.g., “If I need to pay a balance of $234.5 to my credit card, a water bill of $90.6, an energy bill of $202.3, and a monthly mortgage of $1851.7, how much in total I need to pay this month?”), using the fine-tuned LLM. The prompt herein can include, for instance, the query (e.g., “If I need to pay a balance of $234.5 to my credit card, a water bill of $90.6, an energy bill of $202.3, and a monthly mortgage of $1851.7, how much in total I need to pay this month?”), metadata associated with a predefined list of APIs, and/or an instruction to generate a tool-use representation (as described previously or elsewhere of this disclosure).

An executor can be invoked to execute the python interpreter using the parameters and values for the parameters (e.g., the python code of “a=234.5, b=90.6, c=202.3, d=1851.7, print(a+b+c+d)), to generate an execution result (e.g., 2379.1). In this example, the text reasoning block can be updated to include the execution result, and the LLM-based assistant (or a system including the LLM-based assistant) can further determine whether the updated text reasoning block (or the tool-use representation that includes the updated text reasoning block) is missing any information to generate a response for the query (e.g., “If I need to pay a balance of $234.5 to my credit card, a water bill of $90.6, an energy bill of $202.3, and a monthly mortgage of $1851.7, how much in total I need to pay this month?”).

The LLM-based assistant (or the system) can determine whether the updated text reasoning block (or the tool-use representation that includes the updated text reasoning block) is missing any information to generate a response for the query using various approaches. For example, an additional prompt can be generated to include the query (e.g., “If I need to pay a balance of $234.5 to my credit card, a water bill of $90.6, an energy bill of $202.3, and a monthly mortgage of $1851.7, how much in total I need to pay this month?”), the tool-use representation that includes the updated text reasoning block, the metadata associated with the predefined list of APIs, and/or the instruction to generate a tool-use representation. The additional prompt can be processed as input, using the fine-tuned LLM, to generate a second model output indicating, for instance, end of reasoning. Based on the second model output indicating end of reasoning, the LLM-based assistant (or the system) can determine that the updated text reasoning block (or the tool-use representation that includes the updated text reasoning block) is not missing any information to generate a response for the query. The LLM-based assistant (or the system) can further update the updated text reasoning block (or the tool-use presentation) by adding an indication (e.g., <end-of-reasoning>) indicating “an end of reasoning” to the end of the updated text reasoning block.

Based on the further updated text reasoning block (or the tool-use representation) including the indication (e.g., <end-of-reasoning>) that indicates an end of reasoning, the LLM-based assistant (or the system) can generate a response for the query. For example, when the query is “If I need to pay a balance of $234.5 to my credit card, a water bill of $90.6, an energy bill of $202.3, and a monthly mortgage of $1851.7, how much in total I need to pay this month?”), the generated response can be, for instance, “Based on the information you provided, the total amount to pay this month should be $2379.1.” The generated response (e.g., “Based on the information you provided, the total amount to pay this month should be $2379.1”) can be rendered, e.g., using the rendering engine 102, in response to the query (e.g., “If I need to pay a balance of $234.5 to my credit card, a water bill of $90.6, an energy bill of $202.3, and a monthly mortgage of $1851.7, how much in total I need to pay this month?”).

In some implementations, instead of classifying the user input/query, the user query classification engine 125 can be applied to classify content from a human-to-computer dialog (or a portion thereof), to determine whether the human-to-computer dialog (or the portion thereof) includes a tool-use request or a particular type of tool-use request. The human-to-computer dialog (or the portion thereof) can include one or more user inputs (e.g., from a single user or from different users) and/or one or more assistant inputs that are generated by the LLM-based assistant based on the one or more user inputs. The one or more assistant inputs can be generated based on template(s) and/or based on ML model(s) including but not limited to the LLM(s).

In some implementations, the server computing device 12 (or the client computing device 10) can further include a tool-use representation engine 127 and/or an end-of-reasoning detection engine 128. The tool-use representation engine 127 can be configured to generate or update a tool-use representation based on model output(s) of the fine-tuned LLM (e.g., LLM 190C in FIG. 1B) that is generated based on prompt(s) derived at least from a user query. For instance, given the user query (or a human-to-computer dialog that includes the user query) being classified as including a tool-use request, the prompt-generating engine 120 can generate a first prompt (e.g., a tool-use prompt) based on the user query. For instance, the first prompt can include the user query, metadata associated with a list of tools (or a list of APIs), and an instruction to generate a tool representation.

In response to the prompt-generating engine 120 generating the first prompt, a first iteration of LLM processing can be performed. For instance, the first prompt can be processed as input using the fine-tuned LLM 190C (see in FIG. 1B), to generate a first model output. The tool-use representation engine 127 can generate a tool-use representation based on the first reasoning block. For example, in response to the fine-tuned LLM outputting the first model output, the tool-use representation engine 127 can generate the tool-use representation by including the first reasoning block in the tool-use representation. The end-of-reasoning detection engine 128 can determine, based on the tool-use representation that includes the first reasoning block, whether a response can be generated for the user query. For example, the end-of-reasoning detection engine 128 can determine whether the first reasoning block is a tool call reasoning block identifying an API to be called/executed, or whether the first reasoning block is a text reasoning block that misses any information to generate a response for the user query.

For example, in response to the end-of-reasoning detection engine 128 determining that the first reasoning block is a text reasoning block includes information needed to generate a response for the user query, the end-of-reasoning detection engine 128 can produce an indication (e.g., an end-of-reasoning text such as <end-of-reasoning>) that indicates end-of-reasoning, and attach the indication that indicates the end-of-reasoning at the end of the tool-use representation. In response to detecting that the tool-use representation includes the indication that indicates the end-of-reasoning, the LLM-based assistant (or the system) can generate a response based on the tool-use representation.

In response to the tool-use representation not including the indication that indicates the end-of-reasoning, a second iteration of LLM processing can be performed. For example, for the second iteration of LLM processing, a second prompt can be generated. The second prompt can include, for instance, the tool-use representation that includes the user query, the metadata associated with the list of tools (or the list of APIs), the first reasoning block, and/or the instruction to generate a tool-use representation. In case the first reasoning block is a tool call reasoning block, the tool-use representation can further include an execution result acquired by, e.g., executing an API identified in the tool call reasoning block, using parameters and parameter values (for the parameters) associated with the API.

During the second iteration of LLM processing, the second prompt can be processed as input using the fine-tuned LLM 190C, to generate a second model output from which a second reasoning block is derived. The tool-use representation engine 127 can update the tool-use representation to include the first reasoning block (which can include an execution result if the first reasoning block is a tool call reasoning block) and the second model output (which can include an execution result if the second reasoning block is another tool call reasoning block). The end-of-reasoning detection engine 128 can determine, based on the updated tool-use representation, whether a response for the user query can be generated. In response to the end-of-reasoning detection engine 128 determining that a response can be generated based on the updated tool-use representation, the end-of-reasoning detection engine 128 can add an indication that indicates the end of reasoning at an ending area of the updated tool-use representation, and the LLM-based assistant (or the system) can generate a response based on the updated tool-use representation.

Otherwise, a third iteration (or more iteration(s)) of LLM processing can be performed until the end-of-reasoning detection engine 128 produces an indication that indicates the end of reasoning. For example, for the third iteration, a third prompt can be generated to include the user query, the metadata associated with the list of tools (or the list of APIs), the first reasoning block (which may include a first execution result acquiring by executing a first API in case the first reasoning block is a tool call reasoning block), the second reasoning block (which may include a second execution result acquiring by executing a second API in case the second reasoning block is another tool call reasoning block), and/or the instruction to generate a tool-use representation. Repeated descriptions for the third iteration of LLM processing are omitted herein, for the sake of brevity.

FIG. 1B illustrates an example scenario showing generation and processing of a prompt determined based on a user query, in accordance with various implementations disclosed herein. As shown in FIG. 1B, a user A may provide user input(s), e.g., via a user input device such as a keyboard or one or more microphones, to interact with an LLM-based assistant. The user input(s) can include a user query 141 that requests to perform a task (tool-based or not tool-based). In some implementations, the user query 141 included in the user input(s) can be a complete query. In some implementations, the user query 141 included in the user input(s) can be an incomplete query that is void of certain content (e.g., one or more values) to perform the task. In this case, the user query 141 can be supplemented with information from subsequent user input, from a human-to-computer dialog containing the user input(s), and/or from metadata associated with the user input(s), to become a complete query.

In some implementations, the user query 141 can be determined or classified as not being (or not including) a tool-use request. In response, a prompt 171 can be generated, where the prompt 171 includes the user query 141 and an instruction 17A to generate a response (e.g., see “145” in FIG. 1B) for the user query 141. The prompt 171 can be processed by the LLM engine 122 using a pre-trained LLM 190A (or the fine-tuned LLM 190C). A model output 174 of the LLM 190A (that is generated based on processing the user query 141) can be processed to generate a response 145 in response to the user query 141. For instance, the user query 141 can be: “what color is the sky?” The prompt 171 can include the user query 141 of “what color is the sky?” and the instruction 17A such as, “generate a response to the above content” or “generate a response to the above user query”, etc. The pre-trained LLM 190A can be pre-trained based on a large quantity of diverse data, including, for instance, an article explaining why the sky is typically blue. In this case, the model output 174 of the pre-trained LLM 190A for the prompt 171 can be derived to result in the response 145, such as “the sky is typically blue during the daytime, and black at night”.

In some implementations, the user query 141 is classified or determined as being (or including) a tool-use request. In response, a prompt 173 different from the prompt 171 can be generated. The prompt 173 can be a tool-use prompt and include at least a tool-use instruction 17B (shortly as “instruction 17B”) in addition to the user query 141. The tool-use instruction 17B can instruct iterative LLM processing responsive to the user query, to each time generate a reasoning block or an indication or text indicating end-of reasoning, where the iterative LLM processing is terminated until the indication or text that indicates end-of reasoning is produced. Optionally, the tool-use instruction 17B can further instruct a final processing of all generated reasoning blocks when the text or indication for end-of reasoning is produced, to generate a response for the user query. The text (or indication) for end-of-reasoning can be, for instance, <END OF REASONING> or <END>.

As a non-limiting example, the instruction 17B can be: “process the user query and the metadata associated with the list of APIs below to generate a reasoning block. Determine whether the reasoning block is enough to generate a response for the user query. For example, if the reasoning block is a tool call reasoning block providing information to call and execute an API, call and execute the API using the provided information, to generate an execution result. Update the reasoning block to include the execute result at the end. If the reasoning block (or the updated reasoning block) is enough to generate a response for the user query, produce ‘<end of reasoning>’ and attach it to the end of the reasoning block. If the reasoning block (or the updated reasoning block) is not enough to generate a response for the user query, generate a new prompt including the user query, the metadata associated with the list of APIs, and the reasoning block. Process the new prompt and repeat steps described above until a reasoning block that, when combined with all previously generated reasoning block, is enough to generate a response for the user query.”

Referring to FIG. 1B and FIG. 2A, the user query 141 can include, for example, a house-searching request, determined based on a human-to-computer dialog (see FIG. 2A) from a user interface 210 of an LLM-based assistant installed at, or accessible via, a client device 200. The user interface 210 can include, for instance, an input field 284 to receive one or more user inputs, a plurality of selectable graphical user interface elements (e.g., 281, 282, and 283) for interacting with the client device 200, and/or a selectable element 285 to enable audible user input.

The human-to-computer dialog can include, for instance, a first user input 201, an assistant input 202, and a second user input 203. The first user input 201 can be, for instance, “I'm looking to rent some houses to buy in Palo Alto from next month”, and the LLM-based assistant can respond to the first user input 201 with the assistant input 202 (which seeks additional information) such as “Sure thing. Do you have any constraints like budget?” In this human-to-computer dialog, the user may provide the second user input 203 of “Yeah something under $3k per month for a 2 bedroom 2 bathroom one”. Based on the human-to-computer dialog, the user query 141 can be determined or classified as a house-searching request that seeks to rent a house to buy in Palo Alto from next month, with a budget under $3k per month for a 2 bedroom 2 bathroom house, can be determined.

In response to determining or classifying the user query 141 as a house-searching request (which is a tool-use request), the prompt 173 can be generated to include the user query 141 (or the human-to-computer dialog) and the tool-use instruction 17B. The prompt 173 can include, for instance, the user query 141, metadata associated with a list of APIs (or a list of tools), and/or an instruction to generate a tool-use representation. Based on the prompt 173, one or more iterations of LLM processing can be performed, by the LLM-based assistant and using the fine-tuned LLM 190C, to generate a tool-use representation that includes one or more reasoning blocks (e.g., each being a model output from the fine-tuned LLM 190C during a respective iteration of LLM processing). The fine-tuned LLM 190C can be acquired based on fine-tuning the pre-trained LLM 190A using one or more training instances 180. But this is not required. For example, the fine-tuned LLM 190C can be acquired based on fine-tuning another pre-trained LLM, or can be acquired based on fine-tuning the pre-trained LLM 190A using another set of training instances, etc.

Referring to FIG. 1B and FIG. 2B, as a non-limiting example, the prompt 173 in FIG. 1B (or 273 in FIG. 2B) can be processed using the fine-tuned LLM 190C during a first iteration of LLM processing, to generate a model output 172 from which a first reasoning block (e.g., Block 1 in FIG. 2B) is derived. The first reasoning block (e.g., Block 1 in FIG. 2B) can be used by the tool-use representation engine 127, to generate a tool-use representation 177. As shown in FIG. 2B, the first reasoning block (Block 1) can, for instance, identify a type of the first reasoning block, which in this case, is “tool call” reasoning block.

The first reasoning block, when being a tool call reasoning block, can include an input (see, e.g., 290 in FIG. 2B) to a tool (or an API associated with the tool), where the input to the tool (or the API) identifies a name (e.g., a tool name) or an identifier of the tool (e.g., a house searching application or service, “house_search”), one or more parameters (e.g., tool parameters) of the tool (or the API), and one or more parameter values (for the one or more parameters) that are determined from the user query (e.g., extracted from the first and second user inputs 201 and 203) that seeks to rent. The tool can be, for instance, a house searching application. The name or identifier of the tool can be, for instance, “house_search”, and the one or more parameters of the tool can include, for instance, a task type of a task to be performed (e.g., buy, rent, sell, etc.), a maximum price and/or a minimum price associated with the task to be performed, a total number of bedrooms, a total number of bathrooms, and/or other parameters. The one or more parameter values for the one or more parameters of the tool to perform the task (e.g., search rent) can be determined from the user query that seeks to rent or from the human-to-computer dialog. For instance, referring to FIG. 2B, the one or more parameter values for the one or more tool parameters can include: “rent” as a parameter value determined for the parameter of “task type”, “$3000” as a parameter value determined for the parameter of “maximum price”, “2” as a parameter value determined for the parameter of “total number of bedrooms”, and “2” as a parameter value determined for the parameter of “total number of bathrooms”.

Based on the input to the tool that is described in the first reasoning block, the task (e.g., searching houses for rent) indicated in the user query can be performed by executing the tool (or the API) indicated in the first reasoning block to generate an execution result (see, e.g., “output” in FIG. 2B), and the first reasoning block (e.g., Block 1 in FIG. 2B) can be updated to include the execution result. For instance, as shown in FIG. 2B, the execution result 291 of the task (e.g., search houses for rent) can include one or more search results for houses available to rent based on the user query that seeks to rent. The one or more search results can include, for instance, a first search result 291A identifying a first house (“House 1”), and/or a second search result 291B identifying a second house (“House 2”). The first search result 291A for the first house can indicate, for instance, that the first house has two bedrooms and two bathrooms, that the first house is for rent at a price of $2,600, that the first house is located at a first address (e.g., #1 . . . , Palo Alto, CA . . . ), and that the first house is described as a nice spacious house overseeing a park. The second search result 291B identifying the second house can indicate, for instance, that the second house has two bedrooms and two bathrooms, that the first house is for rent at a price of $2,950, that the first house is located at a first address (e.g., #2 . . . , Palo Alto, CA . . . ), and that the second house is described to be a big house in a nice neighborhood.

In some implementations, whether the first reasoning block includes an indication for end of reasoning can be determined. For example, a second prompt can be generated to include the the prompt 173 and the tool-use representation 177 (see 29 in FIG. 2B as a non-limiting example), and the second prompt can be processed using the fine-tuned LLM 190C, to generate a model output reflecting another reasoning block or an indication for end of reasoning. In response to the model output (generated using the fine-tuned LLM 190C) during the second iteration of LLM processing indicating end of reasoning, the tool-use representation 177 (e.g., including the first reasoning block such as “Block 1” in FIG. 2B) can be updated to include the indication that indicates end of reasoning (see the term “<END OF REASONING>” in FIG. 2B as a non-limiting example).

In response to detecting a presence of the indication that indicates end-of-reasoning (or “end of reasoning”) in the tool-use representation, a response 143 can be generated. The response 143 can be generated based on processing the tool-use representation, the user query 141, and/or an instruction to generate a response. The response 143 (see “243” in FIG. 2A as a non-limiting example) to the user query 141 (e.g., determined from user inputs 201 and 203 in FIG. 2A) that seeks houses to rent can be, for instance, “I found several 2 bedroom 2 bathroom houses to rent which are under $3k. 1. Nice spacious apartment at #1 . . . , overseeing . . . ; 2. Big house in a nice neighbor at #2 . . . ” or “I found several 2 bedroom 2 bathroom house to rent which are under $3k: 1. Nice spacious house (2b2b) with monthly rent of $2600 at #1 . . . , Palo Alto, CA; 2. Big house (2b2b) with monthly rent of $2950 in a nice neighborhood at #2 . . . , Palo Alto, CA.”

It is noted that the first reasoning block can be, but does not necessarily need to be, a tool call reasoning block. For example, the first reasoning block can be a text reasoning block. The text reasoning block can, but does not necessarily need to, provide a context for a tool call reasoning block. It is noted that, in some implementations, depending on content of the instruction 17B, determining whether the first reasoning block includes an indication for end of reasoning may not involve LLM processing using the fine-tuned LLM 190C. For example, the tool-use representation 177 (that is derived from the model output 172 of the fine-tuned LLM during the first iteration of LLM processing) can be processed (e.g., using a NLU engine and/or a fulfillment engine, which are common modules in natural language processing) to determine whether a response for the user query 141 can be generated. In response to the processing of the tool-use representation 177 resulting in a determination that a response for the user query 141 can be generated based on the tool-use representation 177, the tool-use representation 177 can be updated to include an indication that indicates an end of reasoning. Otherwise, further iteration(s) of LLM processing can be performed to update the tool-use representation 177 (e.g., with one or more reasoning blocks), until a presence of the indication that indicates an end of reasoning is detected in the updated tool-use representation.

In some implementations, in response to the model output (generated using the fine-tuned LLM 190C) during the aforementioned second iteration of LLM processing not indicating end of reasoning (but instead, reflecting a second reasoning block), a third prompt can be generated and a third iteration of LLM processing can be performed. The third prompt can include the user query 141, the metadata associated with the list of tools (or APIs), the tool use representation (that includes the first and second reasoning blocks), and/or the instruction 17B. The third prompt can be processed, using the fine-tuned LLM 190C, to generate a model output reflecting a third reasoning block or an end of reasoning. Repeated descriptions of the third iteration of LLM processing (if any) are omitted herein for the sake of brevity.

FIG. 3A depicts another example of human-to-computer dialog where a response to a tool-based user query is generated using a fine-tuned generative model, in accordance with various aspects of the present disclosure. FIG. 3B depicts another example of a tool-use representation processed using the fine-tuned generative model to generate the response in FIG. 3A.

As shown in FIG. 3A, a user can provide a first user input 301 of “I am going to give you a numerical problem. Can you help solve it”. In receiving the first user input 301, an LLM-based assistant can classify that the user input 301 includes a tool-based request (e.g., perform mathematical operation), and/or can determine that the user input 301 is incomplete (e.g., missing information) to perform the tool-based task. In response to the user input 301, the LLM-based assistant can generate a response 302 such as “Sure thing” to engage the user in providing parameters and/or values of the parameters for the numerical problem. For example, in response to the response 302, the user can further provide a user input 303 of “Adam and Alice are a couple. Adam earns $50k in income per year while Alice earns $55k. If they have two children whose expenses include $2k per month and they have $1.5k of other expenses per month. How much can they save per month?”

In response to receiving the user input 303, the LLM-based assistant can determine that the tool-based request is supplemented with information needed to perform the tool-based task (e.g., a mathematical operation), and thus generate a prompt 373. The prompt 373 can include, for instance, a human-to-computer dialog having the user inputs 301 and 303 (and/or the response 302), or instead, include a user query determined from the human-to-computer dialog. The determined user query can be, for instance, “solve a numerical problem using the following information: ‘Adam and Alice are a couple. Adam earns $50k in income per year while Alice earns $55k. If they have two children whose expenses include $2k per month and they have $1.5k of other expenses per month. How much can they save per month?’”.

In some implementations, the prompt 373 can include metadata associated with a list of tools (or a list of APIs). But this is not required. For instance, the LLM-based assistant may determine that the tool-based request or task(e.g., the mathematical operation) is performable using a particular API, e.g., “Python interpreter”, from the list of available APIs. In this case, the prompt 373 can include only metadata associated with the particular API (e.g., “Python interpreter”).

In some implementations, optionally, metadata associated with an API (or the tool) can include a list of function parameters (and/or types) of the API (or the tool), a type of returned data (e.g., integer, float, boolean, string, or other data type), and/or a document that describes the API (or the tool). In some implementations, the document that describes the API can be a structured (or unstructured) documentation for utilization (e.g., execution) of the API. Such document can include, for instance, a description of API endpoint(s) (also referred to as “resource(s)”, which can be data object(s) such as movies, messages, or service(s)) accessible via the respective API, and a path (e.g., a uniform resource locator, “URL”) to the API endpoint(s). The document can further include an operation ID for an operation (e.g., HTTP method such as “POST”, “GET”, “DELETE”) to be performed on the resources (which, for instance, may be accessible over HTTP protocol) of the respective API, and a parameter list that lists parameters with their names (“language”, “region”), data types (“string” “integer”), and parameter descriptions. The document can further include response format (e.g., JSON) and schema, authentication method, and/or other information (e.g., error codes and descriptions for the error codes) of the API.

In some implementations, optionally, the prompt 373 can further include, but is not required to include, a tool-use instruction. The tool-use instruction (“instruction”) can be, for instance, “process the user query and/or the metadata associated with the list of APIs below to generate a reasoning block. Determine whether the reasoning block is enough to generate a response for the user query. For example, if the reasoning block is a tool call reasoning block providing information to call and execute an API, call and execute the API using the provided information, to generate an execution result. Update the reasoning block to include the execute result at the end. If the reasoning block (or the updated reasoning block) is enough to generate a response for the user query, produce ‘<end of reasoning>’ and attach it to the end of the reasoning block. If the reasoning block (or the updated reasoning block) is not enough to generate a response for the user query, generate a new prompt including the user query, the metadata associated with the list of APIs, and the reasoning block. Process the new prompt and repeat steps described above until a reasoning block that, when combined with all previously generated reasoning block, is enough to generate a response for the user query.”

The prompt 373 can be processed using the fine-tuned LLM 190C, during a first iteration of LLM processing, to generate a first model output from which a first reasoning block (e.g., Block 1 in FIG. 3B) is derived. The first reasoning block can be included in a tool-use representation (shortly as “representation”) 300. As shown in FIG. 3B, the first reasoning block (“Block 1”) can be a text reasoning block. Content of the first reasoning block can include a type of the first reasoning block (e.g., “text reasoning”), and an input 301. The input 301 can include content such as “Let a and b represent the monthly income of Adam and Alice in dollars. a=50/12, b=55/12. If children's expenses and other expenses are represented as c and d respectively, where c=2, d=1.5, the family can save up to: a+b−c−d”. Based on the first reasoning block not ending with (or not followed by) an indication (e.g., <END OF REASONING>) that indicates end of reasoning, a second iteration of LLM processing can be performed, e.g., using the fine-tuned LLM 190C, to generate a second model output of the LLM 190C. To perform the second iteration of LLM processing, an additional prompt (not illustrated) can be generated, where the additional prompt can include the prompt 373 and content from the first reasoning block. The additional prompt can be processed as input, using the fine-tuned LLM 190C, to generate a second model output.

Referring to FIG. 3B, based on the second model output of the LLM 190C generated during the second iteration of LLM processing, a second reasoning block (e.g., “Block 2”) can be determined. Content of the second reasoning block (“Block 2”) can include a type of the second reasoning block, i.e., “tool use” reasoning block. The content of the second reasoning block (e.g., “Block 2”) can further include an input 303A for utilizing a tool such as “python interpreter” and an output 303B (also referred to as “execution result”) from the tool based on execution of the tool using the input 301. The input 305 for utilizing the tool can identify a tool name of the tool (e.g.,: python_code), tool parameters such as “code: a=50/12, b=55/12, c=2, d=1.5, print(a+b−c−d)”. The output 303B can be acquired by executing the code identified in the input 303A using the tool (e.g., having a tool name of “python_code”), and can be, for instance, “6.25” as shown in FIG. 3B.

In some implementations, the tool-use representation 300 can be updated to include the second reasoning block (“Block 2”). In response to the tool-use representation 300 being updated to include the second reasoning block, whether the updated tool-use representation 300 lacks information to generate a response for the user query can be determined. This can be determined using the fine-tuned LLM 190C, or can be determined without using any machine learning model such as the fine-tuned LLM 190C.

For example, in some implementations, in response to determining that the updated tool-use representation 300 includes enough information to generate a response, the tool-use representation 300 that includes the first and second reasoning blocks (“Block 1” and “Block 2”) can be updated to further include an indication (e.g., <“END OF REASONING”>) that indicates end of reasoning. The updated tool-use representation 300 that includes both the first and second reasoning blocks can be processed using (or without using) the fine-tuned LLM 190C, to generate a response 343.

When the fine-tuned LLM 190C is used to generate the response 343, an additional prompt can be generated, where the additional prompt can include the user query, the tool-use representation 300 (that includes both the first and second reasoning blocks “Block 1” and “Block 2”), and an instruction to generate a response. The additional prompt can be processed as input, using the fine-tuned LLM 190C (or the pre-trained LLM 190A, or other generative model), to generate a model output from which the response 343 is derived. The response 343, referring to FIG. 3B, can be “Adam and Alice can save up to $5.75k per month accounting for their income and excluding the expenses you mentioned”. The response 343 can be rendered at the user interface 310 of the LLM-based assistant, via a display of the client device 311.

It is noted that, while the prompt 273 is illustrated in FIG. 2B and the prompt 373 is illustrated in FIG. 3B, the prompt 273 (and the prompt 373) are illustrated for the mere purpose of illustration and in reality, the prompt 273 and the prompt 373 are not intended to be rendered via user interface of the client computing device. In other words, the prompt 273 (or the prompt 373) is generated and processed as input, using the fine-tuned LLM, but is not to be rendered visually or audibly to a human user.

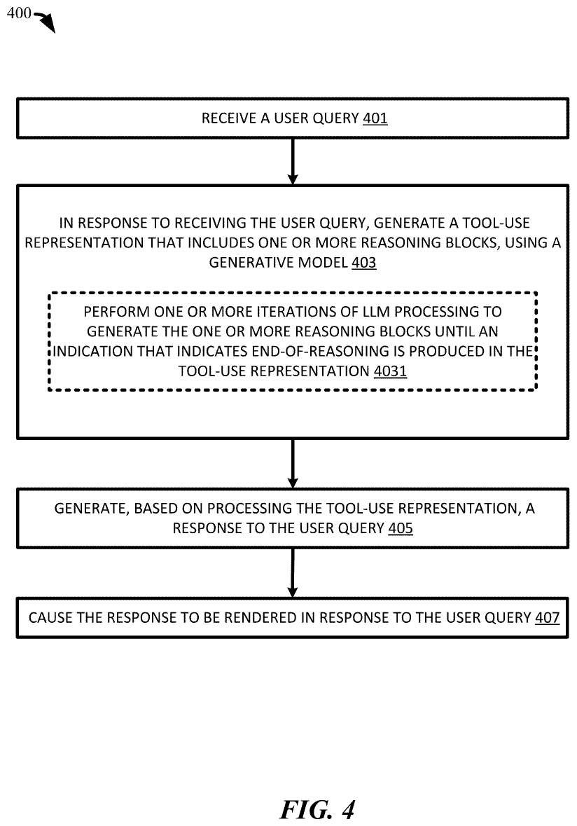

Turning now to FIG. 4, a flowchart illustrating a method of generating a response to a tool-based user query using a fine-tuned generative model, in accordance with various aspects of the present disclosure. A system for performing the method 400 includes one or more processors, memory, and/or other component(s) of computing device(s) (e.g., client computing device 10 of FIG. 1, one or more servers, and/or other computing devices). Moreover, while operations of the method 400 are shown in a particular order, this is not meant to be limiting. One or more operations may be reordered, omitted, and/or added.

At block 401, the system receives a user query. The user query can be determined from one or more user inputs received via a user input device (e.g., a display, one or more microphones, etc.) of a client device. In some implementations, the user query includes a request to perform a mathematical operation. In some implementations, the user query includes a query to access an external source for real-time information. In some implementations, the user query indicates a request to access an external tool (or service).

At block 403, the system, in response to receiving the user query, generates a tool-use representation that includes one or more reasoning blocks, using a generative model. The generative model can be fine-tuned LLM acquiring by fine-tuning a pre-trained LLM that has been pre-trained using extensive training data. The fine-tuned LLM can be used to process a prompt (derived from a user query including a tool-use request) as input, to generate a model output from which a reasoning block is generated. The prompt can include, for instance, the user query, metadata associated with a list of tools (or a list of APIs), and/or an instruction to generate a tool-use representation. It is noted that, the fine-tuned LLM may be fine-tuned in a way such that the instruction to generate a tool-use representation can be omitted from the prompt.

As a non-limiting example, the instruction to generate a tool-use representation can be, “process the user query and/or the metadata associated with the list of APIs below to generate a reasoning block. Determine whether the reasoning block and/or previous reasoning block (if any) is enough to generate a response for the user query. For example, if the reasoning block is a tool call reasoning block providing information to call and execute an API, call and execute the API using the provided information, to generate an execution result. Update the reasoning block to include the execute result at the end. If the reasoning block (or the updated reasoning block) is enough to generate a response for the user query, produce ‘<END OF REASONING>’ and attach it to the end of the reasoning block. If the reasoning block (or the updated reasoning block) is not enough to generate a response for the user query, generate a new prompt including the user query, the metadata associated with the list of APIs, and the reasoning block. Process the new prompt and repeat steps described above until a reasoning block that, when combined with all previously generated reasoning block, is enough to generate a response for the user query.”

In some implementations, the tool-use representation is generated based on the user query being (or including) a tool-use request. In other words, in some implementations, when the user query includes a request that can be fulfilled without using external tools or APIs, the tool-use representation is not generated.

In some implementations, the one or more reasoning blocks can include a first reasoning block derived from a first model output of the fine-tuned LLM that is generated based on processing the aforementioned prompt as input. The first reasoning block can be a tool call reasoning block or a text reasoning block. Depending on whether the first reasoning block is sufficient to generate a response for the user query (e.g., as indicated by whether the first reasoning block includes an indication such as <END OF REASONING> at the end), a response can be generated from the first reasoning block, or a second reasoning block (or more reasoning blocks) can be generated in order to determine a response for the user query.

In some implementations, the one or more reasoning blocks include, at least, a tool call reasoning block that identifies: a tool name of a tool (e.g., an API for hotel booking), one or more tool parameters of the tool, one or more parameter values determined from the user query for the one or more tool parameters, and/or an output from the tool based on processing of the one or more parameter values using the tool.

In some implementations, the one or more reasoning blocks, additionally, or alternatively, include a text reasoning block that includes a text description defining a determination of the one or more parameter values in the tool use reasoning block.

In some implementations, the tool-use representation can be processed to determine whether a response for the user query can be generated. In response to determining that the response for the user query can be generated using the tool-use representation, the tool-use representation can be updated to include (e.g., at the end) an indication (e.g., <END OF REASONING>) that indicates an end of reasoning. In this case, the tool-use representation can be processed to generate the response for the user query. The response for the user query can be generated based on processing the user query, the tool-use representation, and/or an instruction to generate a response, using (or without using) another generative model, where the other generative model can be (but does not necessarily need to be) the fine-tuned LLM.

As shown in FIG. 4, in some implementations, the system generates the one or more reasoning blocks (block 403) by: performing one or more iterations of LLM processing to generate the one or more reasoning blocks until an indication that indicates end-of-reasoning is produced in the tool-use representation (block 4031).

In some implementations, if the user query is not classified as being or including a tool-use request, the system can utilize the fine-tuned LLM (or the trained LLM) to generate a response to the non-tool-use request, without generating the one or more reasoning blocks. In some implementations, in response to the tool-use request being an incomplete request, the LLM-based assistant can generate one or more assistant input and cause the one or more assistant input to be rendered via the client device, to seek additional user input that supplements the incomplete request, until a complete request is acquired.

In some implementations, performing the one or more iterations of LLM processing can be paused when a predefined maximum number of iterative LLM processing is reached, even if an indication that indicates end-of-reasoning has not been produced, to save computational costs and resources. In this case, an error message can be rendered as a response to the user query.

At block 405, the system generates, based on processing the user query and/or the tool-use representation that includes the one or more reasoning blocks, using the generative model, a response to the user query.

At block 407, the system causes the response to be rendered in response to the user query. The response can be rendered visually via a display of the client device, and/or audibly via a speaker of the client device.

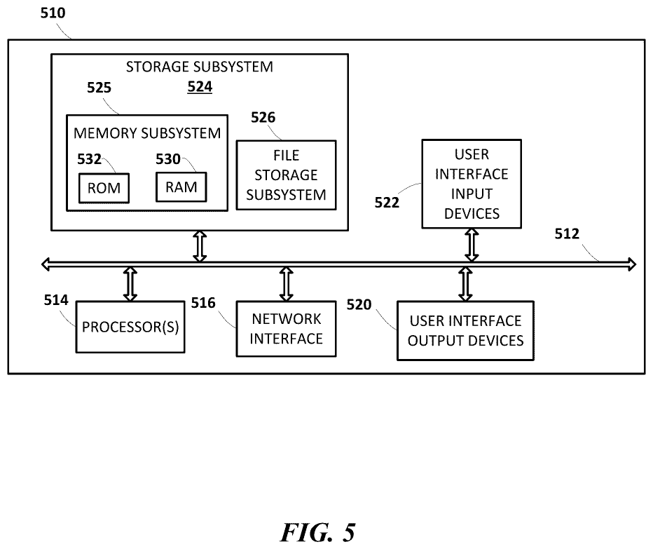

Turning now to FIG. 5, a block diagram of an example computing device 510 that may optionally be utilized to perform one or more aspects of techniques described herein is depicted. In some implementations, one or more of a client device, cloud-based LLM-based assistant component(s), and/or other component(s) may comprise one or more components of the example computing device 510.

Computing device 510 typically includes at least one processor 514 which communicates with a number of peripheral devices via bus subsystem 512. These peripheral devices may include a storage subsystem 524, including, for example, a memory subsystem 525 and a file storage subsystem 526, user interface output devices 520, user interface input devices 522, and a network interface subsystem 516. The input and output devices allow user interaction with computing device 510. Network interface subsystem 516 provides an interface to outside networks and is coupled to corresponding interface devices in other computing devices.

User interface input devices 522 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 510 or onto a communication network.

User interface output devices 520 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 510 to the user or to another machine or computing device.

Storage subsystem 524 stores programming and data constructs that provide the functionality of some or all of the modules described herein. For example, the storage subsystem 524 may include the logic to perform selected aspects of the methods disclosed herein, as well as to implement various components depicted in FIG. 1.

These software modules are generally executed by processor 514 alone or in combination with other processors. Memory 525 used in the storage subsystem 524 can include a number of memories including a main random access memory (RAM) 530 for storage of instructions and data during program execution and a read only memory (ROM) 532 in which fixed instructions are stored. A file storage subsystem 526 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 526 in the storage subsystem 524, or in other machines accessible by the processor(s) 514.

Bus subsystem 512 provides a mechanism for letting the various components and subsystems of computing device 510 communicate with each other as intended. Although bus subsystem 512 is shown schematically as a single bus, alternative implementations of the bus subsystem 512 may use multiple busses.

Computing device 510 can be of varying types including a workstation, server, computing cluster, blade server, server farm, or any other data processing system or computing device. Due to the ever-changing nature of computers and networks, the description of computing device 510 depicted in FIG. 5 is intended only as a specific example for purposes of illustrating some implementations. Many other configurations of computing device 510 are possible having more or fewer components than the computing device depicted in FIG. 5.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

Some other implementations disclosed herein recognize that training a generative model can require a significant quantity (e.g., millions) of training instances. Due to the significant quantity of training instances needed, many training instances will lack input and/or output properties that are desired when the generative model is deployed for utilization. For example, some training instance outputs for an LLM can be undesirably grammatically incorrect, undesirably too concise, undesirably too robust, etc. Also, for example, some training instance inputs for an LLM can lack desired contextual data such as user attribute(s) associated with the input, conversational history associated with the input, etc. As a result of many of the LLM training instances lacking desired input and/or output properties, the LLM will, after training and when deployed, generate many instances of output that likewise lack the desired output properties.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more transitory or non-transitory computer readable storage media storing computer instructions executable by one or more processors to perform any of the aforementioned methods. Some implementations also include a computer program product including instructions executable by one or more processors to perform any of the aforementioned methods.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, and/or method described herein. In addition, any combination of two or more such features, systems, and/or methods, if such features, systems, and/or methods are not mutually inconsistent, is included within the scope of the present disclosure.

What is claimed is:

1. A method implemented using one or more processors, the method comprising:
receiving a user query;
in response to receiving the user query, generating a tool-use representation that includes one or more reasoning blocks, based on processing one or more prompts, respectively, using a generative model,
wherein the one or more prompts include a first prompt determined from the user query and metadata associated with a list of application programming interfaces (APIs),
wherein the one or more reasoning blocks includes a tool call reasoning block that identifies: an identifier of an API, one or more parameters of the API, and one or more parameter values for the one or more parameters of the API;
generating, based on processing the tool-use representation that includes the one or more reasoning blocks, a response to the user query; and
causing the response to be rendered in response to the user query.

2. The method of claim 1, wherein the one or more reasoning blocks further include a text reasoning block that includes the one or more parameter values.

3. The method of claim 2, wherein the text reasoning block is generated, using the generative model, prior to generating the tool-use representation.

4. The method of claim 2, wherein generating the tool-use representation that includes the one or more reasoning blocks comprises:
processing the first prompt, using the generative mode, to generate a first model output from which the text reasoning block is derived; and
processing a second prompt, using the generative model, to generate a second model output from which the tool call reasoning block is derived, wherein the second prompt is determined from the first prompt and the text reasoning block.

5. The method of claim 1, wherein the tool call reasoning block further includes an execution result acquired based on execution of the API using the one or more parameter values.

6. The method of claim 1, wherein the tool call reasoning block further includes an indication that indicates end of reasoning, and generating the response to the user query is performed in response to detecting the indication that indicates end of reasoning in the tool-use representation.

7. The method of claim 1, wherein the user query includes a request to perform a mathematical operation, and wherein the API is associated with a python code executor.

8. The method of claim 1, wherein the user request is determined from a human-to-computer dialog having one or more turns of user input.

9. The method of claim 2, wherein the human-to-computer dialog further includes one or more turns of assistant input that are generated using an LLM-based assistant that accesses the generative model.

10. The method of claim 9, wherein the user query includes a request to access a tool external to the LLM-based assistant, wherein the tool is associated with one or more APIs.

11. The method of claim 1, further comprising:
determining whether the user query identifies any tool-use task to be performed using one or more APIs, wherein generating the one or more reasoning blocks is in response to determining that the user query identifies a tool-use task.

12. A method implemented using one or more processors, the method comprising:
receiving one or more user inputs, wherein the one or more user inputs are provided via a user interface of an LLM-based assistant accessible via a client device, and wherein the LLM-based assistant accesses a generative model and a list of application programming interfaces (APIs);
determining that the one or more user inputs indicate a request to perform an application action via an application that is external to the LLM-based assistant;
in response to receiving the user query and in response to determining that the one or more user inputs indicate the request to perform the application action, generating one or more reasoning blocks using the generative model,
wherein the one or more reasoning blocks includes a tool call reasoning block that identifies: an identifier of an API from the list of APIs, one or more parameters of the identified API, and one or more parameter values for the one or more parameters of the identified API;
generating, based on processing the one or more reasoning blocks, a response to the user query; and
causing the response to be rendered in response to the user query.

13. The method of claim 12, wherein the one or more reasoning blocks further include a text reasoning block that includes the one or more parameter values.

14. The method of claim 13, wherein the text reasoning block is generated, using the generative model, prior to the tool call reasoning block.

15. The method of claim 13, wherein generating the tool-use representation that includes the one or more reasoning blocks comprises:
processing the first prompt, using the generative model, to generate a first model output from which the text reasoning block is derived; and
processing a second prompt, using the generative model, to generate a second model output from which the tool call reasoning block is derived, wherein the second prompt is determined from the first prompt and the text reasoning block.

16. The method of claim 12, wherein the tool call reasoning block further includes an execution result acquired based on execution of the API using the one or more parameter values.

17. The method of claim 12, wherein the tool call reasoning block further includes an indication that indicates end of reasoning, and generating the response to the user query is performed in response to detecting the indication that indicates end of reasoning in the tool-use representation.

18. The method of claim 12, wherein the user query includes a request to perform a mathematical operation, and wherein the API is associated with a python code executor.

19. A system comprising one or more processors and memory storing instructions that, when executed, causes the one or more processors to:
receive a user query;
in response to receiving the user query, generate a tool-use representation that includes one or more reasoning blocks, based on processing one or more prompts, respectively, using a generative model,
wherein the one or more prompts includes a first prompt determined from the user query and metadata associated with a list of application programming interfaces (APIs),
wherein the one or more reasoning blocks includes a tool call reasoning block that identifies: an identifier of an API, one or more parameters of the API, and one or more parameter values for the one or more parameters of the API;
generate, based on processing the tool-use representation that includes the one or more reasoning blocks, a response to the user query; and
cause the response to be rendered in response to the user query.

20. The method of claim 19, wherein the one or more reasoning blocks further include a text reasoning block that includes the one or more parameter values, and wherein the text reasoning block is generated, using the generative model, prior to the tool call reasoning block.
